(19) United States
(12) Patent Application Publication
(10) Pub. No.: US 2003/0041290 A1
(43) Pub. Date: Feb. 27, 2003

(54) Method for monitoring consistent memory contents in redundant systems

(76) Inventor: Pavel Peleska, Graefelfing (DE)

Correspondence Address: Morrison & Foerster LLP, Suite 300, 1650 Tysons Boulevard, McLean, VA, 22102, US

(21) Appl. No.: 10/189,185

(22) Filed: Jul. 5, 2002

(30) Foreign Application Priority Data
Aug. 23, 2001 (EP) 01120256.1

(51) Int. Cl. H04B 1/74

(52) U.S. Cl. 714/47

(57) ABSTRACT

In a fault-tolerant system which is constructed from two control devices that operate in lockstep mode, e.g. both control devices are performing the same work at any given point in time, there is a requirement to check whether consistent, e.g. words identical, contents are being read from or written to the main memory at the same point in time in order to be able to detect any errors which may be occurring as quickly as possible and thus to prevent any spreading of the error. Known methods achieve this with the aid of dedicated north bridges which provide information by way of a separate interface, or by means of a monitoring of other operations, for example I/O transactions possibly on the PCI bus. According to the invention, the checking of the memory contents for consistency is performed with the aid of simple devices—memory monitoring module, checking device and is controlled by the checking device.

### CLAIM FOR PRIORITY

This application claims priority from European patent application EP01120256.1 filed Aug. 23, 2001.

### TECHNICAL FIELD OF THE INVENTION

The invention relates to a fault-tolerant system, and in particular, to a fault-tolerant system including two control devices that operate in lockstep mode.

### BACKGROUND OF THE INVENTION

In a fault-tolerant system constructed from two identical control devices that operate in lockstep mode, i.e. both control devices are performing the same work at any given point in time, there is a requirement to check whether consistent, i.e. identical words, contents are being read from or written to the main memory at the same point in time. This ensures the detection of any errors which may be occurring as quickly as possible and thus to prevent any spreading of the error. Known methods for checking for consistent memory contents can be subdivided into direct and indirect methods.

In the direct method, a hardware-based method, in which a dedicated north bridge is used, which makes available, by way of a separate interface, information concerning transactions in which the north bridge is involved, i.e. also concerning memory transactions.

The following problems are encountered with the direct method:

The development effort for a dedicated north bridge is substantial.

In the case of a north bridge integrated into the CPU in order to enhance the performance, the use of a dedicated north bridge is not possible.

In the indirect method, due of the lack of direct access facilities to the north bridge and its interfaces, I/O transactions for example may be monitored on the PCI bus instead of the memory transactions which cannot be monitored directly. As a result of indirect monitoring, the problem arises whereby errors or asynchronous modes of operation are capable of being detected considerably later than is possible in the case of direct monitoring of the memory transactions.

### SUMMARY OF THE INVENTION

The present invention discloses, in one embodiment, methods for monitoring consistent memory contents in redundant systems.

One advantage of the invention includes, for example, a direct and immediate examination of the memory contents for consistency carried out with the aid of simple devices—e.g., memory monitoring module, checking device—and is controlled by the checking device. A north bridge is therefore not required for sampling the memory contents. Furthermore, control of the method being effected by the checking device ensures that the checking is carried out without I/O accesses to peripheral modules, for example by way of the PCI bus system.

In another embodiment, a small number of constantly accessible external signals error checking code signals from the memory interface—is advantageously sampled on the north bridges by the memory monitoring modules. This permits a substantially simpler design compared with the sampling of data signals and/or address signals from the memory interface, but nonetheless guarantees a high error detection performance. As a result of the use of external signals by the north bridges, the method can also be used if CPU and north bridge are combined in a single module.

In another embodiment, since the function of the checking device is restricted to the comparison of two signatures, the control of the memory monitoring module, and where applicable the raising of an alarm condition, the logic to be implemented in the checking device is simple. Nevertheless, as a result of the use of signatures which are based on the ECC information, a very high degree of reliability in the detection of errors is guaranteed which is comparable with the performance of the error detection on the memory interface resulting from the ECC information.

### BRIEF DESCRIPTION OF THE DRAWINGS

The invention will be described in the following with reference to the drawing, in which:

FIG. 1 shows a first and second control unit in a fault tolerant system.

### DETAILED DESCRIPTION OF THE PREFERRED EMBODIMENTS

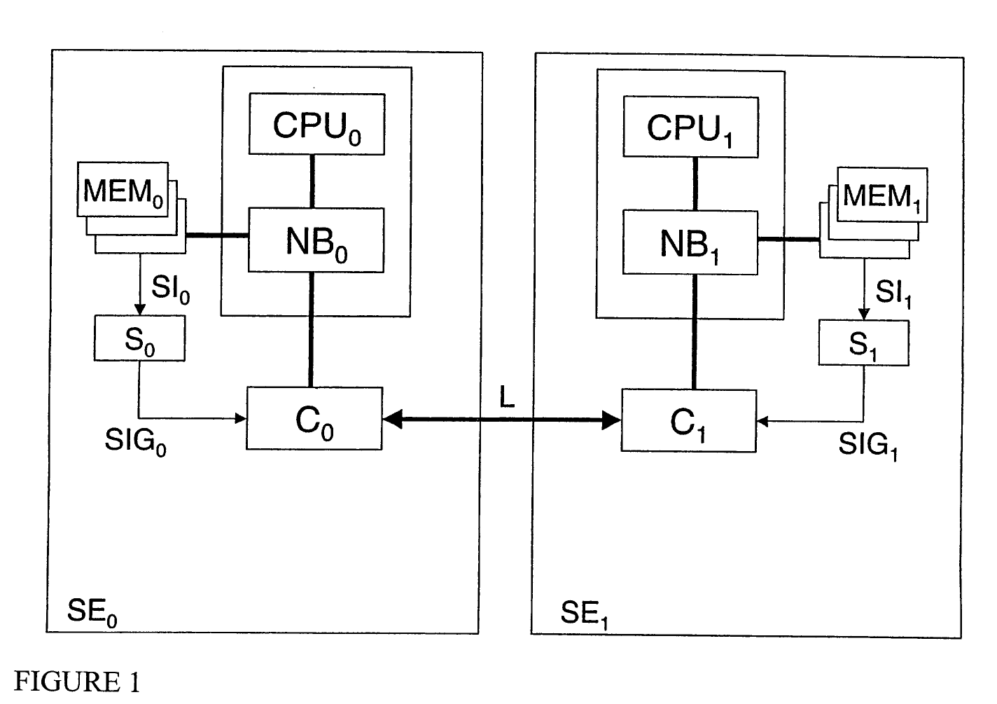

FIG. 1 shows a first control unit SE₀ and a second control unit SE₁ of a fault-tolerant system. Both control units SE₀ and SE₁ are of identical construction and each includes a processing unit CPU₀, CPU₁, an interface unit or North Bridge NB₀, NB₁, and a memory MEM₀, MEM₁, implemented for example in the form of SDRAM, DDR-SDRAM or QDR-SDRAM. The functionality of the processing units CPU₀, CPU₁ and of the North Bridges NB₀, NB₁ can, as shown, be implemented in two separate devices, or combined in a single device (not shown).

In addition, for each of the two control devices SE₀, SE₁ the figure shows a checking device C₀, C₁ according to the invention, each having a memory monitoring module, or snooper S₀, S₁.

The checking devices C₀, C₁ are each by preference a field programmable gate array FPGA or an application specific integrated circuit ASIC. However, it is also possible to implement the function of the checking devices C₀, C₁ in a program-controlled fashion by using a micro-controller for each.

The two control devices SE₀, SE₁ operate in lockstep mode, e.g. both control devices SE₀, SE₁ and each of the aforementioned devices assigned to the control devices SE₀, SE₁ are performing the same work at any given point in time. The methods and devices for establishing and monitoring the lockstep operation are not the subject of the present invention and are not described. However, it is assumed in the following that the timing is synchronized for the two control devices SE₀, SE₁.

The first snooper S₀ of the first control device SE₀ observes the accesses of the first North Bridge NB₀ of the first control device SE₀ to the first memory MEMO of the first control device SE₀. To this end, the first snooper S₀ is connected to the control lines and at least to the ECC—error checking code lines of the first memory interface SI₀ of the first control device SE₀.

Similarly, the second snooper S₁ of the second control device SE₁ is connected to the control lines and at least to the ECC lines of the second memory interface SI₁ of the second control device SE₁, and observes the accesses of the second North Bridge NB₁ of the second control device SE₁ to the second memory MEM₁ of the second control device SE₁.

Since the two snoopers S₀, S₁ are acquainted with the memory control protocol and use the control signals which are transferred over the control lines of the respective memory interfaces SI₀, SI₁ to monitor operational sequences, the snoopers S₀, S₁ can sample the valid ECC information at the correct point in time at the relevant memory interface SI₀, SI₁.

This ECC information is transferred by the snoopers S₀, S₁ in its entirety or in part to the relevant checking device C₀, C₁ in the form of signatures SIG₀, SIG₁, i.e. the signature SIF₀ from snooper S₀ is transferred to the checking device C₀ and the signature SIG, from snooper S₁ is transferred to the checking device C₁. The signatures SIG₀, SIG₁ are then transferred by the checking devices C₀, C₁ via the link L to the other respective checking device C₀, C₁, such that the signatures SIG₀, SIG₁ of both snoopers S₀, S₁ are present in both checking devices C₀, C₁.

Subsequently, the signatures SIG₀, SIF₁ received from the assigned snooper S₀, S₁ of the respective control device SE₀ and SE₁ are checked by the checking devices C₀, C₁ for equality with the signature SIG₀, SIG₁ received from the other checking device C₀, C₁, i.e. checking device C₀ compares the signature SIG₀ received from snooper S₀ with the signature SIG₁ received from checking device C₁, and checking device C₁ compares signature SIG₁ received from snooper S₁ with signature SIG₀ received from checking device C₀.

If an inequality is noted, an alarm condition is raised to the effect that differing memory transactions have taken place. This alarm condition is forwarded for example by way of the link between the checking devices C₀, C₁ and the associated North Bridges NB₀, NB₁ to the associated North Bridges NB₀, NB₁ and from there to the processing units CPU₀, CPU₁, and can occur in the form of an interrupt with the appropriate priority in conjunction with a corresponding interrupt handling routine. With regard to the connection between the checking devices C₀, C₁ and the associated North Bridges NB₀, NB₁, this is a connection implemented by means of a standard interface, for example a PCI bus or AGP bus.

Such an alarm condition may be an indication of an asynchronous state affecting the control devices SE₀, SE₁ or an indication of a processing error in at least one of the control devices SE₀, SE₁ or an indication of a memory error in at least one of the control devices SE₀, SE₁. Methods for the isolation and handling of an error leading to the alarm condition in the interrupt handling routine are adequately known and are not the subject of the present invention.

The ECC information and thus the signatures SIG₀, SIG₁ formed from the ECC information depend on the data bits read or written such that the ECC information or the signatures SIG₀, SIG₁ are sufficient in order to be able to differentiate with a high degree of probability whether equal or unequal data has been read or written.

One advantage is that it is not necessary to connect the snoopers S₀, S₁ to the data lines and to assess these. The number of data lines for commonly encountered systems is an integer multiple of 64, for example therefore 128 data lines, whereas 8 ECC lines are present, whereby a simpler construction is possible both for the snoopers S₀, S₁ and also for the checking devices C₀, C₁.

If the address of the memory access is incorporated in the formation of the ECC information and thus in the signatures SIG₀, SIG₁, the addresses of the memory accesses are thereby also indirectly monitored.

The invention is not restricted to the embodiments described above. For example, if checking devices C₀, C₁ and/or the link L are to be designed with a lower performance level, the control of the snoopers S₀, S₁ can be implemented such that not every sampled item of ECC information is selected for the checking process and forwarded as signature SIG₀, SIG₁ to the checking devices C₀, C₁, but every n-th sampled item of ECC information, for example every second or every tenth sampled item of ECC information. Whilst this result in a reduced capability of the method to immediately detect and handle deviating ECC information and thus deviating memory contents, the demands relating to the performance level of the checking devices C₀, C₁ and of the link L are also lessened at the same time. Depending on the particular application, the parameter n can be adapted to suit the requirements, whereby in the case n=1 every sampled item of ECC information is checked as described in the preferred embodiment.

If the address of the memory access is not incorporated in the formation of the ECC information and thus in the signatures SIG₀, SIG₁ snoopers S₀, S₁ can be provided which are additionally connected to all or selected address lines. This means that monitoring of the addresses of the memory accesses can also take place.

The method according to the invention can also be used whenever the memory MEM₀, MEM₁ and/or the North Bridges NB₀, NB₁ do not supply any ECC information on the memory interface SI₀, SI₁ Snoopers S₀, S₁ can then be provided which are connected to the data lines of the memory interface SI₀, SI₁ and compute a signature SIG₀, SIG₁ from these signals. Amongst other things, this has the advantage that, compared with memory interfaces SI₀, SI₁ offering ECC information, merely one other snooper S₀, S₁ needs to be provided but not another monitoring device C₀, C₁.

What is claimed is:

1. A method for monitoring consistent memory contents in a redundant system, comprising:
a first control unit and a second control unit each having a processing unit with an interface unit and a memory, wherein
each memory of a respective control unit is monitored by a memory monitoring module,
signatures are formed by the memory monitoring modules, which represent information written to each memory or read from each memory, and which are forwarded to a respective monitoring device,
the signatures are forwarded by the monitoring devices to the other respective monitoring device via a link between the control units, where at least one of the monitoring devices compares the signature received from the memory monitoring module with the signature received from the other monitoring device, and
an alarm condition is raised by the monitoring device carrying out the comparison if the compared signatures are determined to be non-matching.

2. The method according to claim 1, wherein the signatures are formed from an error checking code information formed during each write and/or read access to the memory.

3. The method according to claim 1, wherein a field programmable gate array or an application specific integrated circuit or a micro-controller is provided for checking devices, such that at least one of the checking devices raises the alarm condition, and
a connection of the checking devices to the interface unit including the memory interface or to the processing unit with an integrated interface unit is implemented by a bus system.

4. A system for monitoring consistent memory contents in a redundant system, comprising:
a first control unit and a second control unit, each having a processing unit with an interface unit and a memory and a memory monitoring module for monitoring the memory, which forwards signatures that represent information written to the memories or read from the memories to a respective checking device, wherein
the checking device receiving the signatures from the memory monitoring module by a link, and the checking device compares the received signature and raises an alarm condition in the event of deviations.

5. A memory monitoring module, comprising:
a first device to monitor a memory interface of a memory; and
a second device to provide a signature derived from error checking code information formed during write and/or read access to the memory and sampled at the memory interface.

6. The memory monitoring module according to claim 5, wherein the memory monitoring module involves all or selected data lines and/or all or selected address lines and/or all or selected control lines of the memory interface in the formation of the signatures.

7. A checking device of a redundant system, comprising:
a first device to receive a first signature which represents a data word written to a first memory of a first control device assigned to the checking device or a data word read from the first memory;
a second device to receive a second signature which represents a data word written to a second memory of a second, redundant control device or a data word read from the second memory; and
a third device to compare the first and the second signature, having a fourth device to raise an alarm condition in the event of a second signature deviating from the first signature.

8. The checking device according to claim 7, wherein the checking device is a field programmable gate array or an application specific integrated circuit or a micro-controller, and
the checking device is connected by a bus system or an interface to an interface unit including a memory interface or to a processing unit with an integrated interface unit.

9. The checking device according to claim 7, wherein the checking device includes a memory monitoring module with a unit to monitor the memory interface of the memory and a unit to provide signatures which represent information written to the memory or read from the memory.

10. The checking device according to claim 8, wherein the checking device includes a memory monitoring module with a unit to monitor the memory interface of the memory and a unit to provide signatures which represent information written to the memory or read from the memory.
